(19) United States
(12) Patent Application Publication
(10) Pub. No.: US 2016/0296056 A1
(43) Pub. Date: Oct. 13, 2016

(54) AN EXHAUST HOOD FOR COOKERS

(71) Applicant: ARCELIK ANONIM SIRKETI, Istanbul (TR)

(72) Inventors: Can Onur VANCI, Istanbul (TR); Serdal Korkut AVCI, Istanbul (TR); Nihat DURAN, Istanbul (TR); Ozgur Mutlu OZ, Istanbul (TR); Tolga INAM, Istanbul (TR); Koray AYDOGDU, Istanbul (TR); Oliver HUANG, Istanbul (TR); Ozgur OZTURK, Istanbul (TR); Ugur CAMLI, Istanbul (TR)

(21) Appl. No.: 15/100,332

(22) PCT Filed: Oct. 27, 2014
(86) PCT No.: PCT/EP2014/073011

§ 371 Date: May 30, 2016

(30) Foreign Application Priority Data
Nov. 28, 2013 (TR) A 2013/13901

(51) Int. Cl. A47J 27/62; G06F 3/01; G01K 1/08

(52) U.S. Cl. CPC A47J 27/62; G01K 1/08; G06F 3/01

(57) ABSTRACT

The present invention relates to an exhaust hood (1) comprising a body (2) that is positioned above the cooker (O) such that there is a distance between the cooker (O) and the body (2), a projector (3) that is disposed on the body (2) and that can project onto the cooker (O) and/or the countertop (T) that surrounds the cooker (O) and whereon the cooker (O) is seated, a sensor (4) that is disposed on the body (2) and that can detect the movement in the area scanned, a virtual keyboard (5) that is projected by the projector (3), and a control unit (6) that is disposed on the body (2) and that performs operations by means of the virtual keyboard (5).

The present invention relates to an exhaust hood that can project onto a surface.

In the exhaust hood that controls the household appliances, a projector that projects a virtual keyboard and a sensor that detects the movement and/or the change in the scanned area are provided. The control unit controls the household appliances depending on the data entered by the user by means of the virtual keyboard. The projector and the sensor positioned on the exhaust hood operate with the sensor detecting the hand movements corresponding to the virtual keyboard projected on the cooker and the countertop around the cooker by the projector and thus sending command to the household appliances with wireless communication protocol or with cable connection. However, the user perception should be increased carefully while the said system is used in a cooker that heats up so as to prevent dangerous situations.

In the state of the art International Patent Application No. WO2010135478A2, household appliances are disclosed, that are controlled by means of virtual keyboards.

The aim of the present invention is the realization of an exhaust hood that projects an indicator which provides ease of utilization.

The exhaust hood realized in order to attain the aim of the present invention, explicated in the first claim and the respective claims thereof, comprises a body that is positioned above the cooker so that a distance remains therebetween and that sucks the vapor coming from the cooking containers on the cooker; a projector that is disposed on the body so as to project onto and/or the vicinity of the cooker, a sensor that detects the movement in the area scanned, a virtual keyboard that is projected by the projector and that is controlled by the fingers of the user, and a control unit that performs operations according to the command entered by the virtual keyboard.

The exhaust hood of the present invention furthermore comprises the cooker having more than one burner thereon and controlled by the virtual keyboard and at least one indicator that is projected by the projector and activated by the user by means of the virtual keyboard.

In an embodiment of the present invention, the exhaust hood comprises the virtual keyboard projected onto the countertop and more than one figure arranged on the virtual keyboard, each one symbolizing one burner and activating the burner it represents when pressed thereon.

In an embodiment of the present invention, the exhaust hood comprises the virtual keyboard projected onto the countertop and the indicators arranged on the virtual keyboard, each one symbolizing one burner and projected onto the burner it represents when pressed thereon.

In an embodiment of the present invention, the figures are positioned on the virtual keyboard with the same arrangement as the burners.

In an embodiment of the present invention, the figure remains in the active mode (A) as long as the burner it represents is active, and remains in the passive mode (P) while the said burner is in the passive position. The figure is shown by shapes and/or colors that can be more easily perceived in the active mode (A).

In an embodiment of the present invention, the indicator has a first symbol that remains on the cooker and shows the burner and a second symbol that remains on the countertop and that shows the temperature data of the said burner.

In an embodiment of the present invention, the indicator comprises a connector that connects the first symbol and the second symbol to one another. Thus, which burner the second symbol represents can be perceived better.

In an embodiment of the present invention, the indicator is stopped being projected by the control unit in the situation the cooking container placed thereon is larger than itself.

In an embodiment of the present invention, the exhaust hood comprises a temperature processing means that is disposed on the cooker and that detects the temperature of the burner. The control unit enables an alerting symbol to be projected by the projector depending on the temperature data received from the temperature processing means.

In an embodiment of the present invention, the alerting symbol is projected to the said burner by the control unit and by means of the projector if the temperature of the said burner is greater than the temperature value predetermined by the producer after the cooking container is taken off the burner.

In an embodiment of the present invention, the cooker comprises a switch that turns off the cooker safely and quickly.

By means of the present invention, an exhaust hood is realized that controls the cooker by a control unit and by means of the projector and the sensor.

The exhaust hood realized in order to attain the aim of the present invention is illustrated in the attached figures, where:

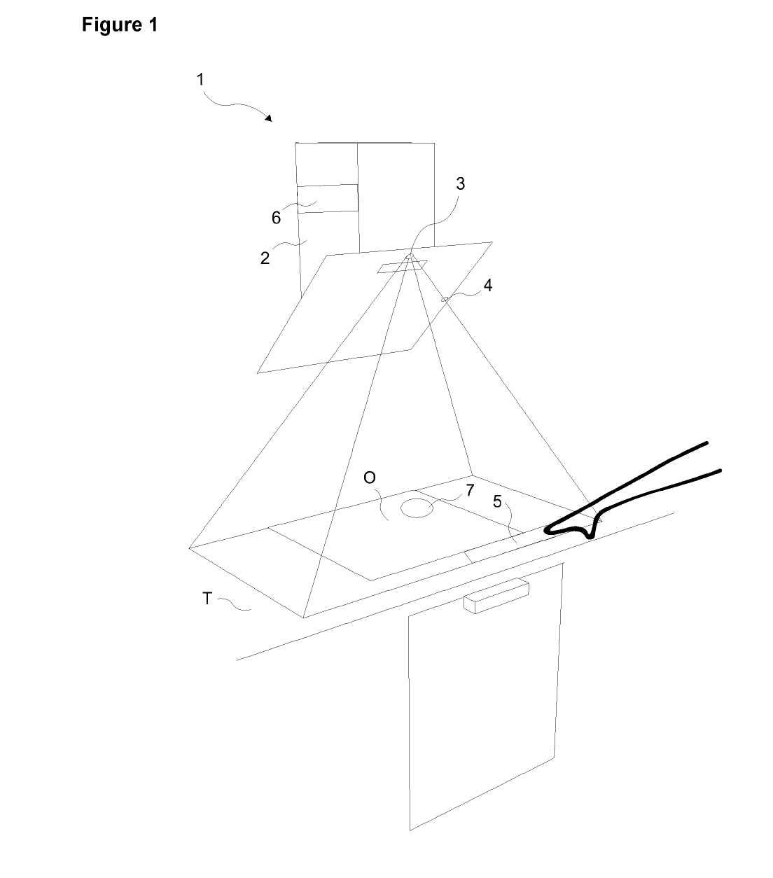

FIG. 1—is the schematic view of a cooker and an exhaust hood having a projector and a sensor.

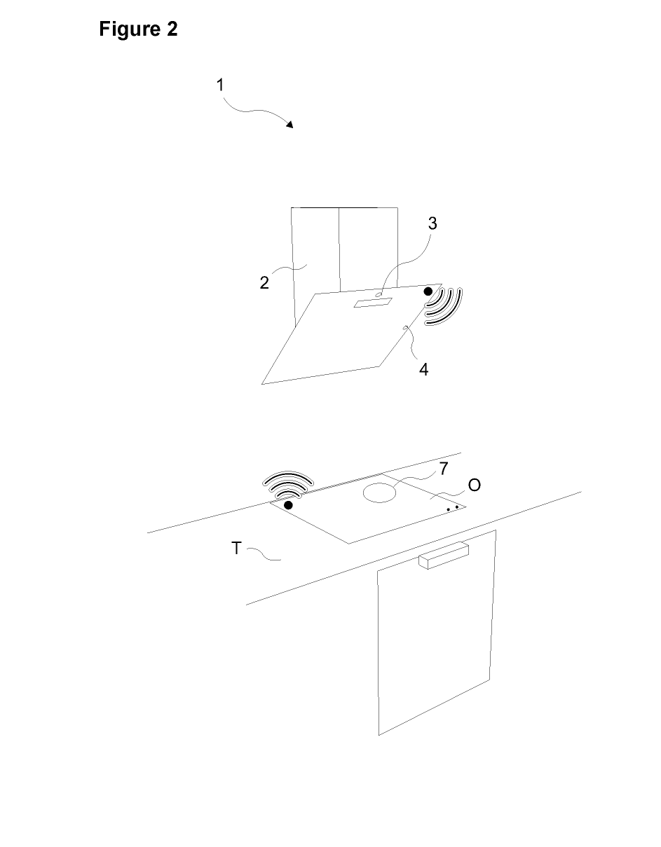

FIG. 2—is the schematic view of a cooker and an exhaust hood having a projector and a sensor.

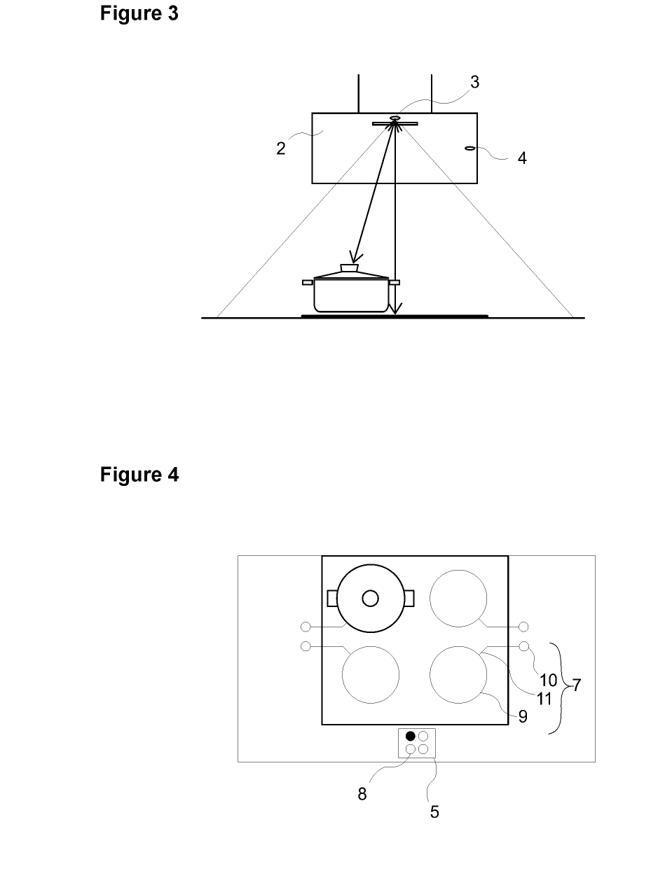

FIG. 3—is the schematic view of a cooker and an exhaust hood having a projector and a sensor.

FIG. 4—is top schematic view of the cooker and the countertop in another embodiment of the present invention.

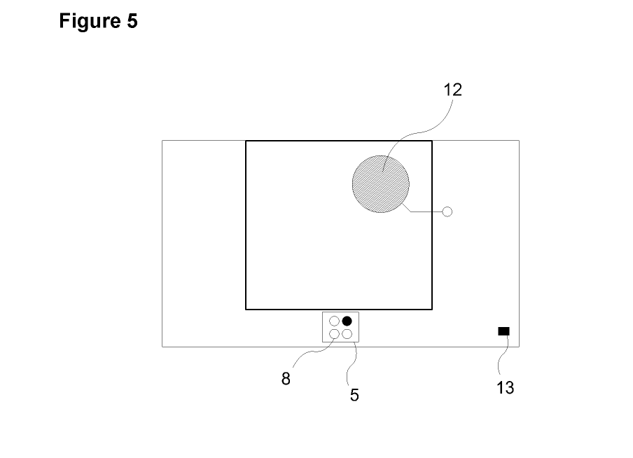

FIG. 5—is top schematic view of the cooker and the countertop in another embodiment of the present invention.

The elements illustrated in the figures are numbered as follows:
1. Exhaust hood
2. Body
3. Projector
4. Sensor
5. Virtual keyboard
6. Control unit
7. Indicator
8. Figure
9. First symbol
10. Second symbol
11. Connector
12. Alerting symbol
13. Switch
O. Cooker
T. Countertop

The exhaust hood (1) of the present invention comprises a body (2) that is positioned above the cooker (O) such that there is a distance between the cooker (O) and the body (2), a projector (3) that is disposed on the body (2) and that can project onto the cooker (O) and/or the countertop (T) that surrounds the cooker (O) and whereon the cooker (O) is seated, a sensor (4) that is disposed on the body (2) and that can detect the movement in the area scanned, a virtual keyboard (5) that is projected by the projector (3), and a control unit (6) that is disposed on the body (2) and that performs operations by means of the virtual keyboard (5).

The exhaust hood (1) of the present invention furthermore comprises the cooker (O) that is controlled by the virtual keyboard (5), having more than one burner thereon and at least one indicator (7) that is activated by the user by means of the virtual keyboard (5) and projected onto the burners by the projector (3) so that each burner is perceived (FIG. 1, FIG. 2, FIG. 3).

The control unit (6) generates a depth map by means of the sensor (4). This depth map obtained is transmitted to the processor module (PC) used in the system and in this processor module (PC) it is followed by defining the human hand by using the algorithm determined by the producer. The finger and hand movements are detected by the sensor (4) and converted into vectorial data by the control unit (6), and the household appliances are controlled by the control unit (6) by means of the said vectorial data.

The exhaust hood (1) can be changed to the active or passive position by means of an turn on/turn off key disposed on the body (2). The user controls the control unit (6) with the virtual keyboard (5) that is projected onto the countertop (T) by means of the projector (3). Wireless communication is established between the exhaust hood (1) and the cooker (O). The command entered via the virtual keyboard (5) is transmitted to the cooker (O). The virtual keyboard (5) is projected onto the cooker (O) and/or an area close to the cooker (O). In the cooker (O) that is used by means of the projection made by the projector (3), the location of the burners is perceived again by means of the indicator (7) projected onto the cooker (O). Thus, a cooker (O) is realized having a flat structure, that does not require any indicators thereon, and thus decreasing the production costs and providing ease of utilization for the user.

In an embodiment of the present invention, the exhaust hood (1) comprises the virtual keyboard (5) projected onto the countertop (T) and more than one figure (8) arranged on the virtual keyboard (5), each one symbolizing one burner and that activates the burner it represents when pressed thereon. The figures (8) are positioned on the virtual keyboard (5). Each of the said figures (8) corresponds to one burner. The user changes the desired burner to the active and/or passive position by pressing on the said corresponding figures (8) (FIG. 4, FIG. 5).

In an embodiment of the present invention, the exhaust hood (1) comprises the virtual keyboard (5) projected onto the countertop (T) and more than one figure (8) arranged on the virtual keyboard (5), each one symbolizing one burner and activating the indicator (7) corresponding to the burner it represents when pressed thereon. At the moment the user presses on the figure (8), the indicator (7) is projected onto the burner the figure (8) represents. Thus, the user can see which burner is active.

In an embodiment of the present invention, the figures (8) are positioned on the virtual keyboard (5) with a similar arrangement as the burners. The figures (8) that represent the burners are disposed in the same order and arrangement on the virtual keyboard (5) as the burners are arranged on the cooker (O). A more convenient perception is created for the user.

In an embodiment of the present invention, the figure (8) remains in the active mode (A) as long as the corresponding burner is active, and remains in the passive mode (P) while the said corresponding burner is in the passive position. The figure (8) that is in the active mode (A), with for example a dark color, that creates the user perception, remains in the active mode (A) as long as the burner it represents is active. Thus, the user perceives better which burner is active.

In an embodiment of the present invention, the indicator (7) has a first symbol (9) that remains on the cooker (O) and shows the burner and a second symbol (10) that remains on the countertop (T) and shows the temperature data of the said burner. The temperature data of the said burner is read by means of the second symbol (10) that is disposed on the countertop (T), in the vicinity of the burner it represents. The second symbol (10) being on the countertop (10) prevents it from being covered by the cooking container.

In an embodiment of the present invention, the indicator (7) comprises a connector (11) that connects the first symbol (9) and the second symbol (10) to one another. Thus, which burner the second symbol (10) represents can be perceived better.

In an embodiment of the present invention, the indicator (7) is stopped being projected by the projector (3) by means of the control unit (6) in the situation the cooking container placed thereon is larger than itself. The sensor (4) perceives the height and size thereof. In the situation the cooking container protrudes out of the area predetermined by the producer, the control unit (6) automatically cuts off the projection of the indicator (7) to that burner.

In an embodiment of the present invention, the exhaust hood (1) comprises a temperature processing means that is disposed on the cooker (O) and that detects the temperature of the burner. The control unit (6) enables an alerting symbol (12) to be projected by the projector (3) depending on the temperature data (S) received from the temperature processing means (FIG. 5).

In an embodiment of the present invention, the alerting symbol (12) is projected to the said burner by the control unit (6) and by means of the projector (3) if the temperature of the said burner is greater than the temperature value (SR) predetermined by the producer after the cooking container is taken off the burner. The alerting symbol (12) projected to the burner is turned off by the control unit (6) depending on the said burner temperature falls below the temperature value (SR). The cooking container can be detected by the sensor (4) or by a separate sensor means disposed in the cooker (O).

In an embodiment of the present invention, the cooker (O) comprises a switch (13) that turns off the cooker (O) safely and quickly (FIG. 5).

By means of the present invention, a cooker (O) that is controlled by the virtual keyboard (5), wherein the perception of the user is increased by means of the indicator (7) projected thereon, and an exhaust hood (1) that controls the said perception are realized.

1- An exhaust hood (1) comprising a body (2) that is positioned above the cooker (O) such that there is a distance between the cooker (O) and the body (2), a projector (3) that is disposed on the body (2) and that can project onto the cooker (O) and/or the countertop (T) that surrounds the cooker (O) and whereon the cooker (O) is seated, a sensor (4) that is disposed on the body (2) and that can detect the movement in the area scanned, a virtual keyboard (5) that is projected by the projector (3), and a control unit (6) that is disposed on the body (2) and that performs operations by means of the virtual keyboard (5), characterized by the cooker (O) that is controlled by the virtual keyboard (5), having more than one burner thereon and at least one indicator (7) that is activated by the user by means of the virtual keyboard (5) and projected onto the burners by the projector (3) so that each burner is perceived.

2- An exhaust hood (1) as in claim 1, characterized by the virtual keyboard (5) projected onto the countertop (T) and by more than one figure (8) arranged on the virtual keyboard (5), each one symbolizing one burner and that activates the burner it represents when pressed thereon.

3- An exhaust hood (1) as in claim 2, characterized by the virtual keyboard (5) projected onto the countertop (T) and by more than one figure (8) arranged on the virtual keyboard (5), each one symbolizing one burner and activating the indicator (7) corresponding to the burner it represents when pressed thereon.

4- An exhaust hood (1) as in claim 2, characterized by the figures (8) that are positioned on the virtual keyboard (5) with a similar arrangement as the burners.

5- An exhaust hood (1) as in claim 2, characterized by the figure (8) that remains in the active mode (A) as long as the corresponding burner is active, and remains in the passive mode while the said corresponding burner is in the passive position.

6- An exhaust hood (1) as in claim 2, characterized by the indicator (7) having a first symbol (9) that remains on the cooker (O) and shows the burner and a second symbol (10) that remains on the countertop (T) and shows the temperature data of the said burner.

7- An exhaust hood (1) as in claim 6, characterized by the connector (11) that is disposed on the indicator (7) and that connects the first symbol (9) and the second symbol (10) to one another.

8- An exhaust hood (1) as in claim 2, characterized by the indicator (7) that is stopped being projected by the projector (3) by means of the control unit (6) in the situation the cooking container placed thereon is larger than itself.

9- An exhaust hood (1) as in claim 2, characterized by a temperature processing means that is disposed on the cooker (O) and that detects the temperature of the burner and by the control unit (6) that enables an alerting symbol (12) to be projected by the projector (3) depending on the temperature data received from the temperature processing means.

10- An exhaust hood (1) as in claim 9, characterized by the alerting symbol (12) that is projected to the said burner by the control unit (6) and by means of the projector (3) if the temperature of the said burner is greater than the temperature value predetermined by the producer after the cooking container is taken off the burner.

11- An exhaust hood (1) as in claim 2 characterized by a switch (13) that is disposed on the cooker (O) and that turns off the cooker (O) safely and quickly.

12- An exhaust hood (1) as in claim 3, characterized by the figures (8) that are positioned on the virtual keyboard (5) with a similar arrangement as the burners.

13- An exhaust hood (1) as in claim 3, characterized by the figure (8) that remains in the active mode (A) as long as the corresponding burner is active, and remains in the passive mode while the said corresponding burner is in the passive position.

14- An exhaust hood (1) as in claim 3, characterized by the indicator (7) having a first symbol (9) that remains on the cooker (O) and shows the burner and a second symbol (10) that remains on the countertop (T) and shows the temperature data of the said burner.

15- An exhaust hood (1) as in claim 14, characterized by the connector (11) that is disposed on the indicator (7) and that connects the first symbol (9) and the second symbol (10) to one another.

16- An exhaust hood (1) as in claim 3, characterized by the indicator (7) that is stopped being projected by the projector (3) by means of the control unit (6) in the situation the cooking container placed thereon is larger than itself.

17- An exhaust hood (1) as in claim 3, characterized by a temperature processing means that is disposed on the cooker (O) and that detects the temperature of the burner and by the control unit (6) that enables an alerting symbol (12) to be projected by the projector (3) depending on the temperature data received from the temperature processing means.

18- An exhaust hood (1) as in claim 17, characterized by the alerting symbol (12) that is projected to the said burner by the control unit (6) and by means of the projector (3) if the temperature of the said burner is greater than the temperature value predetermined by the producer after the cooking container is taken off the burner.

19- An exhaust hood (1) as in claim 3 characterized by a switch (13) that is disposed on the cooker (O) and that turns off the cooker (O) safely and quickly.
